(19) United States
(12) Patent Application Publication
(10) Pub. No.: US 2025/0053914 A1
(43) Pub. Date: Feb. 13, 2025

(54) INSTRUCT SUBSCRIPTION SERVICE SUBSCRIBERS TO OBTAIN PRINTING DEVICE ITEMS FROM FACILITIES

(71) Applicant: Hewlett-Packard Development Company, L.P., Spring, TX (US)

(72) Inventors: Gabriel Scott McDaniel, Boise, ID (US); Justin David Pettingill, Boise, ID (US); Paul L Jeran, Boise, ID (US); Jeffrey Harold Luke, Boise, ID (US)

(21) Appl. No.: 18/718,049

(22) PCT Filed: Dec. 14, 2021
(86) PCT No.: PCT/US2021/063389

§ 371 Date: Jun. 9, 2024

(51) Int. Cl. G06Q 10/083

(52) U.S. Cl. CPC G06Q 10/083

(57) ABSTRACT

According to examples, an apparatus may include a processor and a memory on which is stored instructions that may cause the processor to determine that a user is within a predefined time period prior to a printing device item being scheduled for automatic shipment to the user. The processor may also determine whether a notice condition has been triggered, in which the notice condition is based on a geolocation of the user and/or historical travel information of the user with respect to a facility at which the printing device item is available. In addition, based on a determination that the notice condition has been triggered and while the user is within the predefined time period, the processor may output a message to the user that the printing device item is available for the user to obtain from the facility.

### BACKGROUND

Printing devices, such as laser printers, typically use a printer cartridge that contains a recording material such as toner to record an image on a medium such as paper. For instance, a recording drum may be charged and a latent image may be formed on the drum by a laser. The latent image may be developed on the drum by developer or toner particles and this image may be transferred directly or indirectly onto a medium.

### BRIEF DESCRIPTION OF DRAWINGS

Features of the present disclosure are illustrated by way of example and not limited in the following figure(s), in which like numerals indicate like elements, in which:

FIG. 1 shows a block diagram of an example apparatus, in which an example processor of the apparatus may output a message to instruct a subscription service subscriber to obtain a printing device item from a facility based on a determination that a notice condition has been triggered;

FIG. 2 depicts a block diagram of an example network environment in which the apparatus depicted in FIG. 1 may be implemented;

FIG. 3 depicts a flow diagram of an example method for outputting a message that a printing device item is available for a subscriber to obtain from a facility based on a determination that a notice condition has been triggered; and

FIG. 4 shows a block diagram of an example computer-readable medium that may have stored thereon computer-readable instructions for outputting a message that a printing device item is available for a subscriber to obtain from a facility based on a determination that a notice condition has been triggered.

### DETAILED DESCRIPTION

For simplicity and illustrative purposes, the principles of the present disclosure are described by referring mainly to examples thereof. In the following description, numerous specific details are set forth in order to provide an understanding of the examples. It will be apparent, however, to one of ordinary skill in the art, that the examples may be practiced without limitation to these specific details. In some instances, well known methods and/or structures have not been described in detail so as not to unnecessarily obscure the description of the examples. Furthermore, the examples may be used together in various combinations.

Throughout the present disclosure, the terms “a” and “an” are intended to denote at least one of a particular element. As used herein, the term “includes” means includes but not limited to, the term “including” means including but not limited to. The term “based on” means based at least in part on.

Some printing supply companies may provide subscription services to subscribers of the subscription services. The subscription services may automatically send supplies, such as printing device items, at certain intervals of time, e.g., on a monthly basis, and/or as the supplies are to be replenished. The companies may thus ship the supplies to the subscribers according to the terms of the subscription service settings. The companies may utilize a number of resources and may incur a number of expenses in shipping the supplies to the subscribers. The resources may include fuel and/or electricity resources used to power vehicles that deliver the supplies to the subscribers. The resources may also include packaging materials used to protect the supplies during shipment of the supplies. The companies may also incur a great deal of monetary costs in order to pay for the fuel and/or electricity resources, the packaging materials, as well as shipping costs.

Disclosed herein are apparatuses that may determine that a subscriber of a subscription service is within a predefined time period prior to a printing device item being scheduled for automatic shipment to the subscriber. That is, an apparatus may include a processor that may determine that the printing device item is to be shipped to the subscriber at a certain date and that a current date is within a predefined time frame prior to the certain date. The processor may determine whether a notice condition has been triggered while the user is within the predefined time period. In other examples, however, the processor may determine that the notice condition has been triggered prior to determining whether the subscriber is within the predefined time period. In any of these examples, the notice condition may be based on a geolocation of the subscriber and/or historical travel information of the subscriber with respect to a facility at which the printing device item is available. For instance, the notice condition may be triggered when the subscriber is within a predefined distance or is predicted to be within the predefined distance of the facility.

Based on a determination that the notice condition has been triggered and while the subscriber is within the predefined time period, the processor may output a message to instruct the subscriber to obtain the printing device item from the facility. The instruction to obtain the printing device item may be a message to the subscriber that the printing device item is available for the subscriber to obtain from the facility. The message may also include an offer of a discount, for instance, on the subscription, to incentive the subscriber to obtain the printing device item from the facility. In instances in which the subscriber obtains the printing device item from the facility, the processor may be notified that the subscriber obtained the printing device item from the facility. In these instances, the processor may cancel the scheduled shipment of the printing device item to the subscriber.

Through implementation of the features of the present disclosure, a subscriber of a subscription service that provides automatic shipment of a printing device item to the subscriber may be notified of instances in which the subscriber may be or may be predicted to be relatively close to a facility at which the subscriber may obtain the printing device item. In instances in which the subscriber obtains the printing device item from the facility based on receipt of the notification, the shipment of the printing device item may not be scheduled or a scheduled shipment may be canceled. As a result, a technical improvement afforded by features of the present disclosure may be the reduction in the consumption of fuel and/or energy as well as shipping materials. The reduction or avoidance of the shipment of the supplies may also reduce air pollution due to the reduction of fuel and/or energy consumption. Other technical improvements may include ancillary savings from motor oil wear, tire wear, mechanical depreciation, etc., of the delivery vehicle(s) as subscribers may be relatively closer in proximity to the suppliers and the suppliers may receive larger shipments and more efficient distribution instruments.

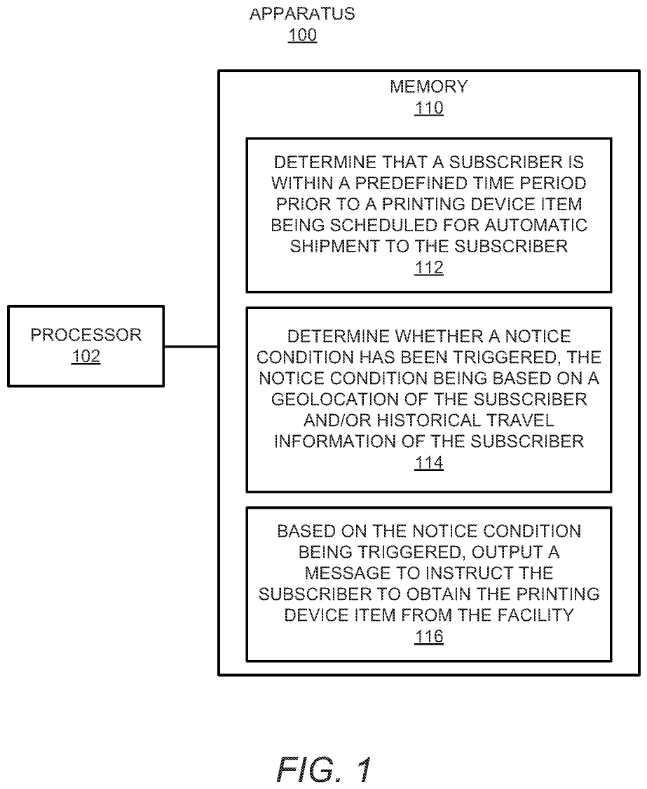

Reference is first made to FIG. 1, which shows a block diagram of an example apparatus 100, in which an example processor 102 of the apparatus 100 may output a message to instruct a subscription service subscriber to obtain a printing device item from a facility based on a determination that a notice condition has been triggered. It should be understood that the example apparatus 100 may include additional features and that some of the features described herein may be removed and/or modified without departing from the scope of the apparatus 100.

Generally speaking, the apparatus 100 may be a computing device such as a server computer. In addition, the processor 102, which may control operations of the apparatus 100, may be a semiconductor-based microprocessor, a central processing unit (CPU), an application specific integrated circuit (ASIC), a field-programmable gate array (FPGA), and/or other hardware device. The apparatus 100 may also include a memory 110, which may also be termed a computer readable medium. The memory 110 may be, for example, a Random Access memory (RAM), an Electrically Erasable Programmable Read-Only Memory (EEPROM), a storage device, or the like. The memory may be a non-transitory computer readable storage medium, where the term “non-transitory” does not encompass transitory propagating signals.

Although the apparatus 100 is depicted as having a single processor 102, it should be understood that the apparatus 100 may include additional processors and/or cores without departing from a scope of the apparatus 100. In this regard, references to a single processor 102 as well as to a single memory 110 may be understood to additionally or alternatively pertain to multiple processors 102 and/or multiple memories 110. In addition, or alternatively, the processor 102 and the memory 110 may be integrated into a single component, e.g., an integrated circuit on which both the processor 102 and the memory 110 may be provided. In addition, or alternatively, the operations described herein as being performed by the processor 102 may be distributed across multiple apparatuses 100 and/or multiple processors 102.

The set of instructions 112-116 that the processor 102 may execute are described herein as being stored on the memory 110. In other examples, however, the instructions 112-116 may be stored directly on the processor 102.

According to examples, the apparatus 100 may be owned and/or operated by a company that may provide subscription services to subscribers. The subscription services may include automatic shipment of printing device items to the subscribers in response to the occurrence of certain events. For instance, the processor 102 may automatically set (e.g., schedule) the printing device items to be shipped on a recurring basis, e.g., monthly, quarterly, yearly, and/or the like. In other examples, the processor 102 may determine that a printing device item of a subscriber is to be replenished and may automatically set the printing device item to be shipped the subscriber. The printing device item may include any suitable type of item that may be consumed or otherwise included in a printing device. For instance, the printing device item may be a printer cartridge containing toner, a printer cartridge containing ink, paper, a waste toner container, a fuser, an intermediate transfer belt, a bin containing materials for use in 3D printing, and/or the like.

By way of particular example, the processor 102 may receive telemetry information from a subscriber's printing device on a regular or irregular basis. For instance, the subscriber's printing device may collect and output the telemetry information on a monthly basis, a quarterly basis, or the like. As another example, the subscriber's printing device may collect and output the telemetry information in response to a determination that a certain event has occurred, in response to a manual instruction to do so, in response to a receipt of a request for the telemetry information, or the like.

The telemetry information may include, for instance, the number of pages printed on the subscriber's printing device over a certain time frame, the amount of toner or ink contained in a cartridge installed in the subscriber's printing device, and/or the like. In this example, the processor 102 may determine whether the number of pages printed exceeds a predefined number for the certain time frame, whether the amount of toner or ink in the cartridge has fallen below a predefined threshold level, and/or the like. Based on a determination that the number of pages printed exceeds the predefined number, the amount of toner or ink in the cartridge has fallen below the predefined threshold level, and/or the like, the processor 102 may schedule a new cartridge to be delivered to the subscriber. The predefined number may be a calculated number and may be static or dynamically modified based on usage by the subscriber.

In any of the examples discussed herein, the processor 102 may schedule the printing device item to be shipped out to the subscriber on a certain date. The certain date may be a date that may enable the printing device item to be delivered to the subscriber before the printing device item is completely depleted with a high degree of certainty. In some examples, the certain date may be determined through data analytics, data modeling, historical data, and/or the like.

The processor 102 may execute the instructions 112 to determine that a subscription service subscriber is within a predefined time period prior to a printing device item being scheduled for automatic shipment to the subscriber. In other words, the processor 102 may determine that a current time is within a predefined time period prior to the certain date at which the printing device item is or is to be set or scheduled to be shipped, mailed, and/or the like. The predefined time period prior to the certain date may be defined, for instance, by an employee of company that provides the subscription services. The predefined time period may additionally or alternatively be determined based on historical data, computer modeling, and/or the like. For instance, the predefined time period may be determined to be a time period at which subscribers obtain the printing device item from facilities a maximum number of times, which may be determined through analysis of historical data and/or computer modeling. By way of particular example, the predefined time period may be around two to three weeks prior to the certain date at which the printing device is or is to be set to be shipped, mailed, and/or the like.

The processor 102 may execute the instructions 114 to determine whether a notice condition has been triggered. As discussed herein, the notice condition may be a condition that, when triggered, causes a notice, e.g., a message to instruct the subscriber to obtain a printing device item from a facility, to be issued. The notice condition may be based on a geolocation of the subscriber and/or historical travel information of the subscriber with respect to a facility at which the printing device item is available. The facility may be a retail store, a warehouse, a distribution center, and/or the like.

In some examples, the notice condition may be based the subscriber's current location with respect to a facility at which the printing device item may be available. That is, the processor 102 may determine whether and/or when the subscriber's current location is within a predetermined distance from the facility. The predetermined distance may be set by an administrator, determined through historical data, through computer modeling, and/or the like. By way of particular example, the predetermined distance may be below around 10 miles from the facility.

The processor 102 may execute the instructions 116 to, based on a determination that the notice condition has been triggered and while the subscriber is within the predefined time period, output a message to instruct the subscriber to obtain the printing device item from the facility. The instruction may be a notification to the subscriber that the printing device item is available at the facility for the subscriber to obtain. The processor 102 may output the message as a short message service (SMS) message, a message through a particular app on the user's smartphone, an email, a phone call, and/or the like. In any of these examples, the notification may be passive, audible, visual, sensory (e.g., vibration), and/or the like.

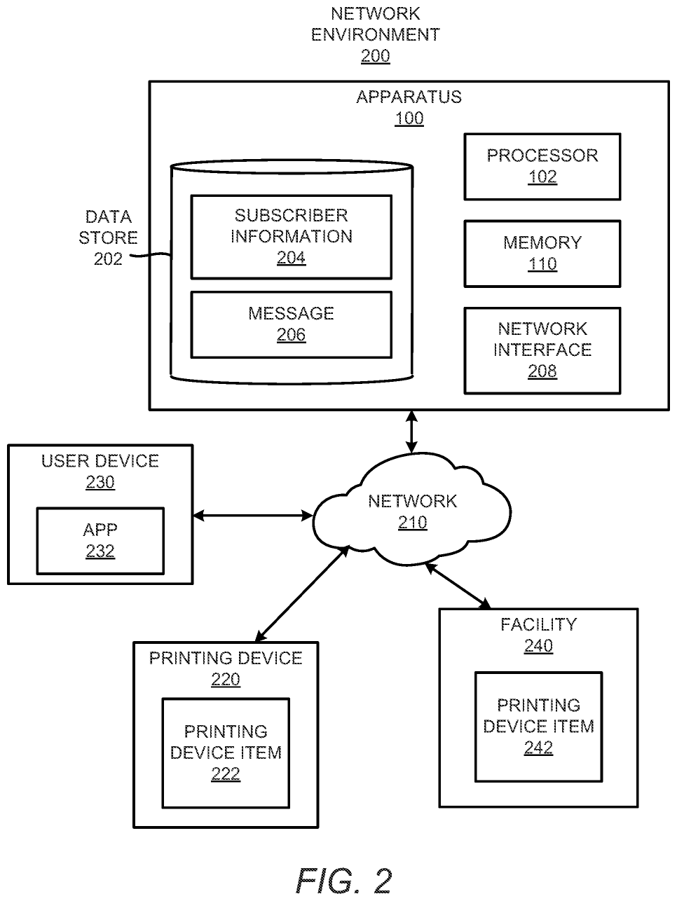

Reference is now made to FIG. 2, which shows a block diagram of an example network environment 200 in which the apparatus 100 depicted in FIG. 1 may be implemented. As shown in FIG. 2, in addition to the apparatus 100, the network environment 200 may include a network 210, a printing device 220, a user device 230, and a facility 240. It should be understood that the example network environment 200 may include additional features and that some of the features described herein may be removed and/or modified without departing from the scope of the environment 200. For instance, the example network environment 200 may include a plurality of apparatuses 100, printing devices 220, user devices 230, facilities 240, and/or printing device items 242.

As shown in FIG. 2, in addition to the processor 102 and the memory 110, the apparatus 100 may include a data store 202 and a network interface 208. The data store 202 may have stored thereon subscriber information 204 and a message 206, which are described in greater detail herein. The network interface 208 may include hardware and/or software that may enable communications by the processor 102 over the network 210. The network 210 may an external network, such as the Internet, a cellular network, and/or the like. In particular examples, the network 210 is the Internet and the apparatus 100 is a cloud-based server.

The printing device 220 may be a laser printer, an inkjet printer, a printing press, or the like that may form images on media, such as paper, using a recording medium, such as toner, ink, or the like. In other examples, the printing device 220 may be a three-dimensional (3D) printer that may form 3D objects from particles of build material through, for instance, selective application of a recording medium, such as a binding agent, ink, or other suitable material onto the particles of build material. In any of these examples, the printing device 220 may include a printing device item 222.

Although a single printing device item 222 has been depicted in FIG. 2, it should be understood that the printing device 220 may include a plurality of printing device items 222. In these instances, the printing device items 222 may include different types of items, such as printer cartridges, bins of 3D print material, paper, and/or the like. By way of example, the printer cartridges may each contain a recording medium having a certain color. As another example, some of the printer cartridges may include a recording medium that has a chemical composition that differs from the recording mediums in other printer cartridges 222.

The printing device item 222 may be a consumable item or may otherwise be removable from the printing device 220. As a result, the printing device item 222 may be replaced when, for instance, the recording medium inside of printer cartridge has reached a sufficiently low level or has been depleted. In other examples, the printing device item 222 may be replaced over time, for instance, as part of a maintenance schedule.

In some examples, the printing device 220 may send telemetry information to the apparatus 100 via the network 210. The telemetry information may include information pertaining to usage of the printing device item 222. For instance, the telemetry information may include a number of sheets printed by the printing device over a certain period of time, a level of material in a cartridge or bin, an age of the printing device item 222, and/or the like.

As discussed herein, the processor 102 may receive the telemetry information from the printing device 220 of the user within which the printing device item 222 is to be used. In addition, the processor 102 may determine that the user is within the predefined time period prior to the printing device item 222 being schedule for automatic shipment to the user from the received telemetry information. The user may be a subscriber of a subscription service provided by an owner or administrator of the apparatus 100 to automatically ship printing device items 222 to subscribers.

Generally speaking, the user device 230 may include a component that may enable the location of the user device 230 to be tracked. For instance, the user device 230 may include a tracking device, such as a global positioning satellite tracking device. As particular examples, the user device 230 may be a smartphone, a smart watch, a tablet computer, a laptop computer, or other mobile electronic device that a user may carry. In some examples, the user device 230 may have installed thereon an app 232, which may be software that may be download onto user devices 230 that may provide access to services provided by a cloud-based service provider. The cloud-based service provider may be a provider of the subscription service, which may also be termed a subscription-based printing service. For instance, the app 232 may access geolocation data on the user device and may communicate the accessed geolocation data to the apparatus 100.

In some examples, the app 232 may access the geolocation data from a global positioning satellite (GPS) component in the user device 230. In these examples, the processor 102 may receive the geolocation data from the app 232 installed on the user device 230. The processor 102 may also determine a location of the user device 230 from the received geolocation data and may compare the determined location of the user device 230 with locations of a plurality of facilities 240 at which the printing device item 242 is available. The processor 102 may further determine whether the user is located within a predetermined distance of the facility 240 at which the printing device item 242 is available based on the comparison.

In other examples, the processor 102 may determine the location of the user using another geolocation technique. For instance, the processor 102 may use other location instruments such as data from cell towers or the IP address of the user device 230. As other examples, RF beacons within facilities 240 or other locations may detect the presence of the user device 230 and the processor 102 may determine the location of the user device 230 based on the detected presence of the user device 230 by the RF beacons.

According to examples, the processor 102 may access historical travel information of the user. For instance, the processor 102 may access historical travel information that has been saved on the user device 230. As other examples, the processor 102 may access the historical travel information from a third party service that may track the user device 230 movements. The third party service may, for instance, provide users with a navigation app that users may use to obtain directions to places. The processor 102 may determine frequently traveled routes of the user and/or a possible location of the user device 230 at a certain time based on the historical travel information.

In any of these examples, the processor 102 may determine whether a notice condition has been triggered, in which the notice condition is based on a geolocation of the user and/or historical travel information of the user with respect to a facility 240 at which the printing device item 242 is available. In some examples, the facility 240 may be on a transaction approval/enabled list for this function, for instance, the facility 240 may have a relationship with the subscription service. The processor 102 may determine whether the notice condition has been triggered while the user is within the predefined time period prior to the printing device item 242 being scheduled for automatic shipment to the user. The notice condition may be a condition that, when triggered, causes a notice, such as an audible and/or visible message to be issued to a user that is to receive the printing device item 232 as part of a subscription service.

In some examples, the processor 102 may determine that the notice condition has been triggered when the processor 102 determines that the geolocation of the user device 230, and thus, the user, is within a predetermined distance of a facility 240 at which a printing device item 242, e.g., a replacement printing device item 242, is available. The predetermined distance may be any suitable distance ranging from anywhere between about zero feet to about 10 miles. As discussed herein, the processor 102 may make this determination through any of a number of various manners.

In some examples, the processor 102 may determine that the notice condition has been triggered when the processor 102 determines that the user device 230, and thus the user, is likely within the predetermined distance of the facility 240. The processor 102 may alternatively determine that the user device 230, and thus the user, is likely to be within the predetermined distance of the facility 240 at a certain time. The processor 102 may make these determinations based on the historical travel information of the user with respect to the facility 240.

As discussed herein, based on a determination that the notice condition has been triggered and while the user is within the predefined time period, the processor 102 may output a message 206 to the user that the printing device item 242 is available for the user to obtain from the facility 240. The message 206 may additionally instruct the user to obtain the printing device item 242 from the facility 240. The message 206 may be a SMS message, an email, a message through the app 232, and/or the like. The message 206 may include an identifier of the printing device item 242, an identification of the facility 240, a location of the facility 240, a location of the printing device item 242 within the facility 240, and/or the like.

The message 206 may also include a machine-readable code that may include information that the user may use in obtaining the printing device item 242 from the facility 240. The machine-readable code may be a quick-response code, a barcode, or the like. In some examples, the message 206 may include payment information such that the user may obtain the printing device item 242 without making a payment or by making a reduced payment as the subscription service provider may guarantee that partial or full payment will be made by the subscription service provider. The machine-readable code may additionally or alternatively include information pertaining to a coupon that the user may use to purchase another item at a reduced price.

According to examples, the processor 102 may access data corresponding to whether the printing device item 242 is respectively available at a plurality of facilities 240. For instance, the processor 102 may have access to the inventories of the plurality of facilities 240 to determine at which of the plurality of facilities 240 the printing device item 242 is available. In these examples, the processor 102 may compare the determined or predicted location of the user device 230 with locations of the plurality of facilities 240 at which the printing device item 242 is available. In addition, the processor 102 may identify the facilities 240 that are within a predefined distance of the user device 230 location and/or the facilities 240 that are predicted to be within the predefined distance of the user device 230 over a certain time frame. The processor 102 may further provide the identifications and/or locations of the identified facilities 240 to the user.

According to examples, the user may present the machine-readable code at the facility 240, such as on a display of the user device 230. A machine at the facility 240 may scan the machine-readable code and the machine may send an indication that the machine-readable code has been scanned at the facility 240 to the apparatus 100. In other words, the apparatus 100 may receive an indication from the facility 240 that the user obtained the printing device item 242 from the facility 240 in response to the machine-readable code being scanned or otherwise entered at the facility 240 at the time the user obtained the printing device item 242 from the facility 240.

The processor 102 may thus determine that the user obtained the printing device item 242 from the facility 240 from the indication received from the facility 240. In other examples, the processor 102 may determine that the user obtained the printing device item 242 from the facility 240 in other manners. For instance, the processor 102 may receive an indication from the user that the user obtained the printing device item 242 from the facility 240. The user may provide this indication through the app 232 on the user device 230.

Based on a determination that the user obtained the printing device item 242 from the facility 240, the processor 102 may cancel the scheduling of the printing device item 242 for automatic shipment to the user. This may include the canceling of a scheduled shipment of the printing device item 242 to the user to thus prevent the printing device item 242 from being shipped to the user. In some examples, the processor 102 may schedule the shipment of a container that the user may use to return the old printing device item 222. In other examples, the processor 102 may provide the user with instructions to return the old printing device item 222 to the facility 240 or to another location for disposal or recyclying.

However, based on a determination that the user has not obtained the printing device item 242 from the facility 240 by a certain date prior to when the printing device item 242 is to be shipped, the processor 102 may not cancel the scheduling of the shipment of the printing device item 242. The certain date may be for instance, a date by which cancelation of the shipment may not be feasible and/or practical. In addition, the processor 102 may send another message to the user that a time window during which the user may have directly obtained the printing device item 242 has passed. The message may also indicate that the printing device item 242 will be shipped to the user at a later date and may include the date on which the user is to expect to receive the printing device item 242 as a delivery.

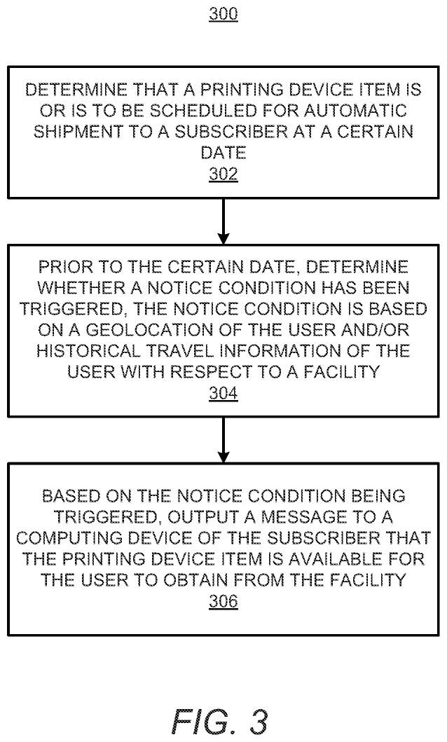

Various manners in which the processor 102 of the apparatus 100 may operate are discussed in greater detail with respect to the method 300 depicted in FIG. 3. Particularly, FIG. 3 depicts a flow diagram of an example method 300 for outputting a message that a printing device item 242 is available for a subscriber to obtain from a facility 240 based on a determination that a notice condition has been triggered. It should be understood that the method 300 may include additional operations and that some of the operations described therein may be removed and/or modified without departing from the scope of the method 300. The description of the method 300 is made with reference to the features depicted in FIGS. 1-2 for purposes of illustration.

At block 302, the processor 102 may determine that a printing device item 242 is or is to be scheduled for automatic shipment to a subscriber of a subscription service at a certain date. The processor 102 may make this determination based on subscriber information 204, which may indicate that the printing device item 242 is to be shipped to the subscriber on a recurring basis and/or based on certain events occurring as discussed herein.

According to examples, the processor 102 may receive telemetry information from a printing device 220 of the subscriber. In these examples, the processor 102 may determine whether a length of time between a first date and the certain date falls within a predefined number of days. In addition, the processor 102 may determine whether the notice condition has been triggered based on a determination that the length of time falls within the predefined number of days.

At block 304, the processor 102 may, prior to the certain date, determine whether a notice condition has been triggered. As discussed herein, the notice condition may be based on a geolocation of the user and/or historical travel information of the user with respect to a facility 240 at which the printing device item 242 is available. In some examples, the processor 102 may determine whether the notice condition has been triggered prior to or concurrently with determining that the printing device item 242 is or is to be scheduled for automatic shipment to the subscriber.

According to examples, the computing device 230 (user device 230) of the subscriber has an app 232 corresponding to the subscription service installed on the computing device 230. The app 232 may access geolocation data on the user's computing device 230. The processor 102 may receive geolocation data from the app 232 installed on the computing device 230. In addition, the processor 102 may determine a location of the computing device 230 from the received geolocation data. The processor 102 may further compare the determined location of the computing device 230 with locations of a plurality of facilities 240 at which the printing device item 242 is available and may determine whether the subscriber is located within a predetermined distance of the facility 240 at which the printing device item 242 is available based on the comparison.

The processor 102 may access data corresponding to which of the plurality of facilities 240 the printing device item 242 is respectively available. The processor 102 may further compare the determined location of the computing device with locations of the plurality of facilities at which the printing device item is available. The processor 102 may still further determine which of the plurality of facilities is the closest to the subscriber or will be the closest to the subscriber during a predicted future travel path.

At block 306, the processor 102 may, based on a determination that the notice condition has been triggered and prior to the certain date, output a message 206 to a computing device 230 of the subscriber. The message 206 may indicate that the printing device item 242 is available for the subscriber to obtain from the facility 240.

According to examples, the processor 102 may receive an indication that the subscriber obtained the printing device item 242 from the facility 240. In addition, the processor 102 may cancel the scheduling of or the scheduled automatic shipment of the printing device item 242 to the subscriber.

Some or all of the operations set forth in the method 300 may be included as utilities, programs, or subprograms, in any desired computer accessible medium. In addition, the method 300 may be embodied by computer programs, which may exist in a variety of forms both active and inactive. For example, they may exist as machine-readable instructions, including source code, object code, executable code or other formats. Any of the above may be embodied on a non-transitory computer readable storage medium.

Examples of non-transitory computer readable storage media include computer system RAM, ROM, EPROM, EEPROM, and magnetic or optical disks or tapes. It is therefore to be understood that any electronic device capable of executing the above-described functions may perform those functions enumerated above.

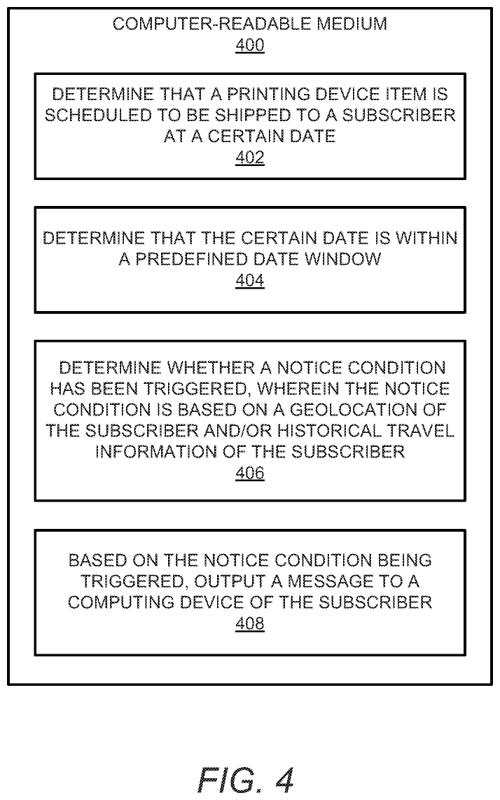

Turning now to FIG. 4, there is shown a block diagram of an example computer-readable medium 400 that may have stored thereon computer-readable instructions for outputting a message 206 that a printing device item 242 is available for a subscriber to obtain from a facility 240 based on a determination that a notice condition has been triggered. It should be understood that the computer-readable medium 400 depicted in FIG. 4 may include additional instructions and that some of the instructions described herein may be removed and/or modified without departing from the scope of the computer-readable medium 400 disclosed herein. The computer-readable medium 400 may be a non-transitory computer-readable medium, in which the term “non-transitory” does not encompass transitory propagating signals.

The computer-readable medium 400 may have stored thereon computer-readable instructions 402-408 that a processor, such as the processor 102 of the apparatus 100 depicted in FIGS. 1 and 2, may execute. The computer-readable medium 400 may be an electronic, magnetic, optical, or other physical storage device that contains or stores executable instructions. The computer-readable medium 400 may be, for example, Random Access memory (RAM), an Electrically Erasable Programmable Read-Only Memory (EEPROM), a storage device, an optical disc, and the like.

The processor may fetch, decode, and execute the instructions 402 to determine that a printing device item 242 is scheduled to be shipped to a subscriber of a subscription service at a certain date. The subscription service may automatically ship the printing device item 242 to the subscriber responsive to an occurrence of a predefined event. The processor may fetch, decode, and execute the instructions 404 to determine that the certain date is within a predefined date window. The predefined date window may be a time frame prior to the certain date that the printing device item 242 is to be shipped to the subscriber and a predefined date. The predefined date may be user-defined, defined based on historical data, modeling, etc., as discussed herein.

The processor may fetch, decode, and execute the instructions 406 to determine whether a notice condition has been triggered. The notice condition may be based on a geolocation of the subscriber and/or historical travel information of the subscriber with respect a facility 240 at which the printing device item 242 is available. In addition, the processor may fetch, decode, and execute the instructions 408 to, based on a determination that the notice condition has been triggered and that the certain date is within the predefined time window, output a message to a computing device 230 of the subscriber. The message 206 may indicate that the printing device item 242 is available for the subscriber to obtain from the facility. Additionally, the message 206 may instruct the subscriber to obtain the printing device item 242 from the facility 240.

According to examples, the processor may receive an indication that the subscriber obtained the printing device item 242 from the facility 240. In addition, the processor may determine from the indication, that the subscriber obtained the printing device item 242 from the facility. Moreover, based on the determination that the subscriber obtained the printing device item 242 from the facility 240, the processor may cancel the scheduled automatic shipment of the printing device item 242 to the subscriber.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What has been described and illustrated herein is an example of the disclosure along with some of its variations. The terms, descriptions and figures used herein are set forth by way of illustration only and are not meant as limitations. Many variations are possible within the scope of the disclosure, which is intended to be defined by the following claims—and their equivalents—in which all terms are meant in their broadest reasonable sense unless otherwise indicated.

What is claimed is:

1. An apparatus comprising:
a processor; and
a memory on which is stored machine-readable instructions that when executed by the processor cause the processor to:
determine that a subscription service subscriber is within a predefined time period prior to a printing device item being scheduled for automatic shipment to the subscriber;
determine whether a notice condition has been triggered, wherein the notice condition is based on a geolocation of the subscriber and/or historical travel information of the subscriber with respect to a facility at which the printing device item is available; and
based on a determination that the notice condition has been triggered and while the subscriber is within the predefined time period, output a message to instruct the subscriber to obtain the printing device item from the facility.

2. The apparatus of claim 1, wherein the instructions cause the processor to:
determine that the subscriber obtained the printing device item from the facility; and
based on the determination that the subscriber obtained the printing device item from the facility, cancel the scheduling of the printing device item for automatic shipment to the subscriber.

3. The apparatus of claim 1, wherein the subscription service includes the automatic shipment of the printing device item to the subscriber.

4. The apparatus of claim 3, wherein a user device of the subscriber has installed thereon an app corresponding to the subscription service, wherein the app is to access geolocation data on the user device, and wherein the instructions cause the processor to:
receive geolocation data from the app installed on the user device;
determine a location of the user device from the received geolocation data;
compare the determined location of the user device with locations of a plurality of facilities at which the printing device item is available; and
determine whether the subscriber is located within a predetermined distance of the facility at which the printing device item is available based on the comparison.

5. The apparatus of claim 4, wherein the instructions cause the processor to:
access data corresponding to whether the printing device item is respectively available at a plurality of facilities; and
compare the determined location of the user device with locations of the plurality of facilities at which the printing device item is available.

6. The apparatus of claim 1, wherein the instructions cause the processor to:
receive telemetry information from a printing device of the subscriber within which the printing device item is to be used; and
determine that the subscriber is within the predefined time period based on the received telemetry information.

7. The apparatus of claim 1, wherein the instructions cause the processor to:
include a machine-readable code in the message outputted to the subscriber, the machine-readable code including information that the subscriber is to use in obtaining the printing device item from the facility.

8. The apparatus of claim 7, wherein the instructions cause the processor to:
receive an indication that the subscriber obtained the printing device item from the facility in response the machine-readable code being scanned at the facility.

9. A method comprising:
determining, by a processor, that a printing device item is or is to be scheduled for automatic shipment to a subscriber of a subscription service at a certain date;
prior to the certain date, determining, by the processor, whether a notice condition has been triggered, wherein the notice condition is based on a geolocation of the subscriber and/or historical travel information of the subscriber with respect to a facility at which the printing device item is available; and
based on a determination that the notice condition has been triggered and prior to the certain date, outputting, by the processor, a message to a computing device of the subscriber, the message indicating that the printing device item is available for the subscriber to obtain from the facility.

10. The method of claim 9, further comprising:
receiving an indication that the subscriber obtained the printing device item from the facility; and
cancelling the scheduling of or the scheduled automatic shipment of the printing device item to the subscriber.

11. The method of claim 9, wherein the computing device of the subscriber has an app corresponding to the subscription service installed on the computing device, wherein the app is to access geolocation data on the computing device and wherein the method further comprises:
receiving geolocation data from the app installed on the computing device;
determining a location of the computing device from the received geolocation data;
comparing the determined location of the computing device with locations of a plurality of facilities at which the printing device item is available; and
determining whether the subscriber is located within a predetermined distance of the facility at which the printing device item is available based on the comparison.

12. The method of claim 11, further comprising:
accessing data corresponding to which of the plurality of facilities the printing device item is respectively available; and
comparing the determined location of the computing device with locations of the plurality of facilities at which the printing device item is available.

13. The method of claim 9, further comprising:
receiving telemetry information from a printing device of the subscriber;
determining whether a length of time between a first date and the certain date falls within a predefined number of days; and
determining whether the notice condition has been triggered based on a determination that the length of time falls within the predefined number of days.

14. A non-transitory computer-readable medium on which is stored machine-readable instructions that when executed by a processor, cause the processor to:
determine that a printing device item is scheduled to be shipped to a subscriber of a subscription service at a certain date, the subscription service to automatically ship the printing device item to the subscriber responsive to an occurrence of a predefined event;
determine that the certain date is within a predefined date window;
determine whether a notice condition has been triggered, wherein the notice condition is based on a geolocation of the subscriber and/or historical travel information of the subscriber with respect a facility at which the printing device item is available; and
based on a determination that the notice condition has been triggered and that the certain date is within the predefined date window, output a message to a computing device of the subscriber, the message indicating that the printing device item is available for the subscriber to obtain from the facility.

15. The non-transitory computer-readable medium of claim 14, wherein the instructions are further to cause the processor to:
receive an indication that the subscriber obtained the printing device item from the facility;
determine, from the indication, that the subscriber obtained the printing device item from the facility; and
based on the determination that the subscriber obtained the printing device item from the facility, cancel the automatic shipment of the printing device item to the subscriber.
